(19) United States
(12) Patent Application Publication
(10) Pub. No.: US 2010/0045162 A1
(43) Pub. Date: Feb. 25, 2010

(54) FLUORESCENT LAMP

(76) Inventor: Satoshi Tamura, Tokyo (JP)

Correspondence Address: Mr. Jackson Chen, 6535 N. STATE HWY 161, IRVING, TX, 75039, US

(21) Appl. No.: 12/536,762

(22) Filed: Aug. 6, 2009

(30) Foreign Application Priority Data
Aug. 19, 2008 (JP) 2008-210550

(51) Int. Cl. H01J 63/04

(52) U.S. Cl. 313/485

(57) ABSTRACT

A fluorescent lamp includes sealed glass tube 1, a pair of opposed electrodes 2 provided in glass tube 1 wire lead 3 one end of which is connected to one of electrodes 2 and the other end of which passes through an end face of glass tube 1 in a gastight manner and is drawn to the outside of glass tube 1, cylindrical member 5 provided at an end of glass tube 1 and containing a portion of wire lead 3 that is drawn to the outside of glass tube 1, and solder portion 6 formed of a solder material contained in the interior of cylindrical member 5, wherein in the cylindrical member 5 an opening 8 is formed that is opposite the end face of the glass tube 1 and solder portion 6 is exposed to the outside in opening 8.

This application is based upon and claims the benefit of priority from Japanese patent application No. 2008-210550, filed on Aug. 19, 2008, the disclosure of which is incorporated herein in its entirety by reference.

### BACKGROUND OF THE INVENTION

1. Field of the Invention

The present invention relates to a fluorescent lamp including a base at each end.

2. Description of the Related Art

A fluorescent lamp typically includes a sealed glass tube, a pair of opposed electrodes provided in the glass tube, and wire leads each connected to each electrode. The fluorescent lamp lights up when a voltage is applied across each electrode through the wire lead.

Some fluorescent lamps include electrically conductive caps (hereafter referred to as bases) at both ends of the glass tube, each connected to a wire lead. The bases of such a fluorescent lamp are inserted in sockets connected to a power supply and thereby the fluorescent lamp is mechanically held by the sockets. At the same time, the fluorescent lamp is electrically connected to the power supply through the sockets and can be supplied with power from the power supply. In this way, the fluorescent lamp can be readily inserted in and withdrawn from the sockets.

FIG. 1 is a schematic diagram illustrating a configuration of one end of a fluorescent lamp relating to the present invention. The fluorescent lamp is a cold cathode fluorescent lamp. While only one end is shown in FIG. 1, the other end has the same configuration.

The fluorescent lamp includes glass tube 11 having phosphor layer 14 formed on its internal surface, opposed electrodes 12 provided in glass tube 11, and wire lead 13 one end of which is connected to one of electrodes 12 and the other end is passed through an end face of glass tube 11 in a gastight manner and is drawn to the outside of glass tube 11. Small amounts of mercury and an inert gas are contained in glass tube 11.

The fluorescent lamp further includes cup member 15 formed in the shape of a cup and put on the end of glass tube 11. Cup member 15 functions as a base. Resin portion 16 is formed in the gap between glass tube 11 and cup member 15 and joins glass tube 11 and cup member 15 together. Wire lead 13 passes through cup member 15 and is soldered onto cup member 15 to form junction 17.

The fluorescent lamp is lit by application of a voltage across each cup member 15 disposed at each end of glass tube 11 to apply the voltage across each electrode 12 through wire lead 13.

In the fluorescent lamp, heat applied during soldering of wire lead 13 onto cup member 15 to form junction 17 is transferred through wire lead 13 to a region in glass tube 11 through which wire lead 13 passes. As a results the region in glass tube 11 through which wire lead 13 passes becomes hotter than the other regions in glass tube 11 and consequently a large temperature difference can develop in glass tube 11. The temperature difference can lead to damage in glass tube 11 which includes hairline cracks in glass tube 11.

In a fluorescent lamp in which a hairline crack in glass tube 11 is caused, a so-called slow leak occurs which allows air to gradually enter glass tube 11. A slow leak in a fluorescent lamp significantly shortens the life of the fluorescent lamp. However, even such a fluorescent lamp that suffers a slow leak can still work for some period of time after it has been manufactured. Therefore, it is difficult to find a hairline crack in glass tube 11 during manufacturing. Thus, it is difficult to ensure high reliability of the fluorescent lamp.

Formation of resin portion 16 of the fluorescent lamp involves curing of a resin material, which typically takes a long time. For example, if resin portion 16 is made of epoxy resin, curing of the epoxy resin takes about a day. Accordingly, it takes much time to manufacture the fluorescent lamp.

A fluorescent lamp designed to solve the problem is described in Japanese Patent Laid-Open No. 7-262910. The interior of a cup member of the fluorescent lamp is filled with a solder material.

FIG. 2 is a schematic diagram illustrating the configuration of one end of the fluorescent lamp having a cup member with the interior being filled with a solder material. The fluorescent lamp includes cup member 25 covering an end of glass tube 21 and solder portion 26 formed of a solder material contained in cup member 25.

In the fluorescent lamp, solder portion 26 joins glass tube 21 and cup member 25 together and electrically connects cup member 25 with wire lead 23. Accordingly, the process for forming solder portion 25 in the manufacturing process of the fluorescent lamp also serves as the process for forming resin portion 16 and the process for forming junction 17 in the manufacturing process of the fluorescent lamp shown in FIG. 1. This enables simplification of the manufacturing process of the fluorescent lamp.

In addition, the manufacturing process of the fluorescent lamp does not include the process for soldering wire lead 23 onto cup member 25 to form a junction. Accordingly, a significant temperature difference does not occur in glass tube 21 of the fluorescent lamp during manufacturing. Accordingly, glass tube 21 of the fluorescent lamp resists damage during manufacturing.

Because a solder material can be hardened more quickly than a resin material, the process for forming solder portion 26 of the fluorescent lamp can be performed in a shorter time than the process for forming resin portion 16 of the fluorescent lamp shown in FIG. 1. Accordingly, the time for manufacturing of the fluorescent lamp can be reduced.

However, when a fluorescent lamp is lit, the fluorescent lamp generates heat. Accordingly, the temperatures of components of the fluorescent lamp rise when the lamp is lit. When the fluorescent lamp shown in FIG. 2 is lit, the temperatures of glass tube 21, solder portion 26, and cup member 25 rise and therefore these components thermally expand.

Glass tube 21 solder portion 26, and cup member 25 are made of materials having different linear expansion coefficients. Accordingly, when these components thermally expand, the components exert forces on one another at the junctions between them. A great force exerted by solder portion 26 on the junction between glass tube 21 and solder portion 26 can damage glass tube 21.

### SUMMARY OF THE INVENTION

An object of the present invention is to provide a fluorescent lamp that suppresses damage to the glass tube.

To achieve the object, a fluorescent lamp according to the present invention includes: a sealed glass tube, a pair of opposed electrodes provided in the glass tube; a wire lead one end of which is connected to one of the electrodes and the other end passes through an end face of the glass tube in a gastight manner and is drawn to the outside of the glass tube, a base provided at an end of the glass tube and that contains a portion of the wire lead that is drawn to the outside of the glass tube; and a solder portion formed of a solder material contained in the interior of the base; wherein in the base an opening is formed that is opposite the end face of the glass tube and the solder portion is exposed to the outside in the opening.

The above and other objects, features and advantage of the present invention will become apparent from the following description with reference to the accompanying drawings which illustrate examples of the present invention.

### BRIEF DESCRIPTION OF THE DRAWINGS

FIG. 1 is a schematic diagram illustrating a configuration of an end of a fluorescent lamp relating to the present invention;

FIG. 2 is a schematic diagram illustrating a configuration of an end of a fluorescent lamp relating to the present invention;

FIG. 3 is a schematic diagram illustrating a configuration of an end of a fluorescent lamp according to an exemplary embodiment; and

FIG. 4 is a schematic diagram illustrating a configuration of an end of a fluorescent lamp according to an exemplary variation of the exemplary embodiment.

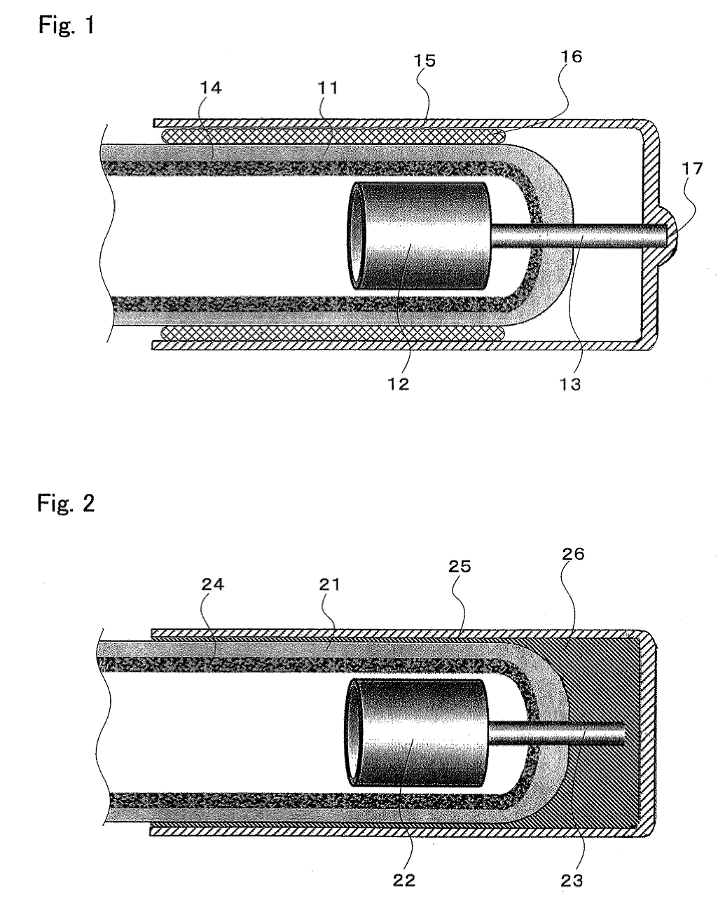

### DESCRIPTION OF THE EXEMPLARY EMBODIMENTS

Exemplary embodiments will be described with reference to the accompanying drawings.

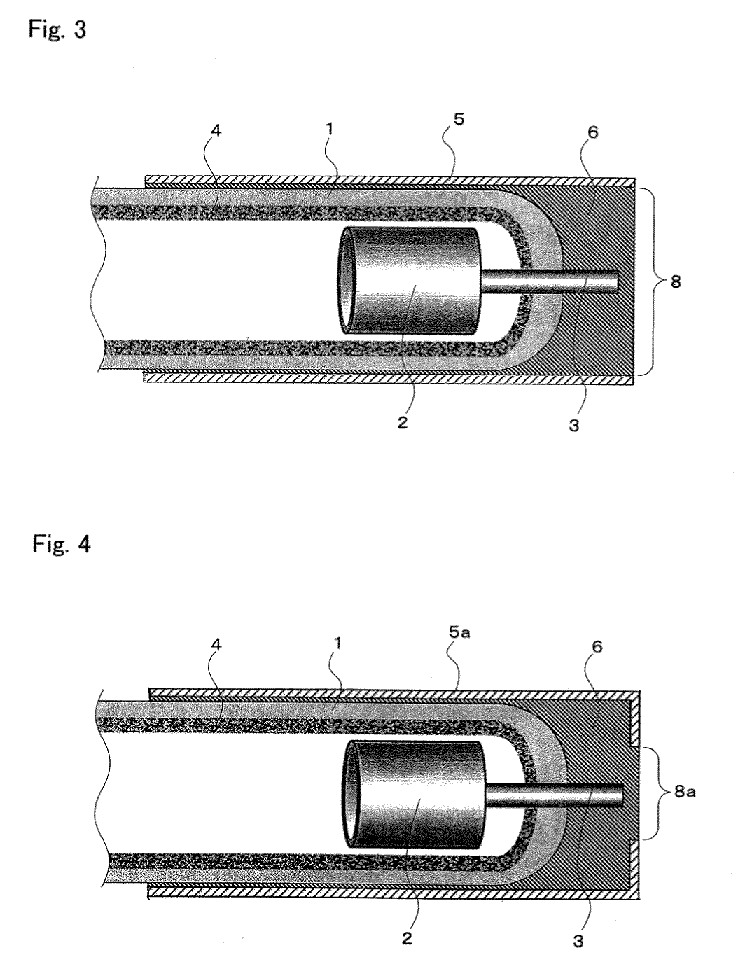

FIG. 3 is a schematic diagram illustrating a configuration of an end of a fluorescent lamp according to an exemplary embodiment. The fluorescent lamp is a cold cathode fluorescent lamp. While only one end is shown in FIG. 3, the other end has the same configuration.

The fluorescent lamp includes glass tube 1 having phosphor layer 4 formed on its internal surface, opposed electrodes 2 provided in glass tube 1, and wire lead 3 one end of which is connected to one of electrodes 2 and the other end is passed through an end face of glass tube 1 in a gastight manner and is drawn to the outside of glass tube 1. Small amounts of mercury and an inert gas are contained in glass tube 1.

The fluorescent lamp also includes cylindrical member 5 formed in the shape of a cylinder and containing an end of glass tube 1 and a portion of wire lead 3 that is drawn outside glass tube 1 and solder portion 6 formed of a solder material contained in the interior of cylindrical member 5. Cylindrical member 5 functions as a base. Solder portion 6 joins glass tube 1 and cylindrical member 5 together and electrically connects cylindrical member 5 with wire lead 3.

Cylindrical member 5 is made of a material having a linear expansion coefficient higher than that of the glass material of glass tube 1 by a value between or equal to 20×10⁻⁷/° C. and 50×10⁻⁷/° C. For example, if the glass material of glass tube 1 has a linear expansion coefficient of 50×10⁻⁷/° C., cylindrical member 5 may be made of a 50 alloy containing 50% iron (Fe) and 50% nickel (Ni) and having a linear expansion coefficient of 80×10⁻⁷/° C.

When the fluorescent lamp is lit, the temperatures of glass tube 1, solder portion 6, and cylindrical member 5 rise and these components thermally expand to exert a force on one another at the junctions between the components.

In the fluorescent lamp shown in FIG. 2, cup member 25, which is a base, includes a bottom and exerts a force on solder portion 26 at the junction between solder portion 26 and the bottom of cup member 25.

On the other hand, in the fluorescent lamp according to the exemplary embodiment, opening 8 is formed at the edge of cylindrical member 5 that faces the end face of glass tube 1 and corresponds to the bottom of cup member 25 of the fluorescent lamp shown in FIG. 2. Accordingly, in opening 8, solder portion 6 is exposed to the outside of cylindrical member 5. Therefore, cylindrical member 5 does not exert a force on solder portion 6 in opening 8. This can reduce the internal stress in solder portion 6 of the fluorescent lamp according to the exemplary embodiment compared with the fluorescent lamp shown in FIG. 2.

The reduction of the internal stress in solder portion 6 can reduce the force exerted by solder portion 6 on glass tube 1 at the junction between glass tube 1 and solder portion 6. This can suppress damage to glass tube 1 in the fluorescent lamp according to the exemplary embodiment.

In order to further reduce the force exerted by solder portion 6 on glass tube 1, the thermal expansion of solder portion 6 may be reduced. To that end, solder portion 6 is preferably made of a solder material having a low linear expansion coefficient. In the fluorescent lamp according to the exemplary embodiment, solder portion 6 is made of a solder material containing tin (Sn) as the main component and at least one from among bismuth (Bi) and indium (In) to reduce the linear expansion coefficient.

While cylindrical member 5 used as the base of the fluorescent lamp according to the exemplary embodiment has an interior diameter equal to the diameter of opening 8, the internal diameter of the base does not necessarily have to be equal to the diameter of the opening. It is essential only that the opening be formed that is opposite the end face of the glass tube. Such a variation will be described with reference to FIG. 4.

FIG. 4 is a schematic diagram illustrating a configuration of the end of a fluorescent lamp including a cup member in place of the cylindrical member of the fluorescent lamp shown in FIG. 3. The fluorescent lamp includes cup member 5a including opening Ba formed in its bottom.

Unlike cup member 25 of the fluorescent lamp shown in FIG. 2, cup member 5a of the fluorescent lamp includes opening 8a formed in its bottom and solder portion 6 is exposed to the outside of cup member 5a in opening 8a. Accordingly, cup member 5a does not exert a force on solder portion 6 in opening 8a.

Therefore, the internal stress in solder portion 6 of the fluorescent lamp shown in FIG. 4 can be reduced compared with that of the fluorescent lamp shown in FIG. 2. Because the reduction of the internal stress reduces the force exerted by solder portion 6 on glass tube 1 at the junction between glass tube 1 and solder portion 6, damage to glass tube 1 can be suppressed.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed:

1. A fluorescent lamp comprising:
a sealed glass tube;
a pair of opposed electrodes provided in the glass tube;
a wire lead one end of which is connected to one of the electrodes and the other end of which passes through an end face of the glass tube in a gastight manner and is drawn to the outside of the glass tube;
a base provided at an end of the glass tube and containing a portion of the wire lead that is drawn to the outside of the glass tube; and
a solder portion formed of a solder material contained in the interior of the base;
wherein in the base an opening is formed that is opposite the end face of the glass tube and the solder portion is exposed to the outside in the opening.

2. The fluorescent lamp according to claim 1, wherein the internal diameter of the base is equal to the diameter of the opening.

3. The fluorescent lamp according to claim 1, wherein the solder portion is made of a material containing tin as a main component and at least one from among bismuth and indium.

4. The fluorescent lamp according to claim 1, wherein the base is made of a material having a linear expansion coefficient higher than that of a glass material of the glass tube by a value between or equal to 20×10⁻⁷/° C. and 50×10⁻⁷/° C.
